(19) United States
(12) Patent Application Publication
(10) Pub. No.: US 2012/0155927 A1
(43) Pub. Date: Jun. 21, 2012

(54) DEVELOPING DEVICE AND METHOD

(75) Inventors: Detlef Schulze-Hagenest, Molfsee (DE); Domingo Rohde, Kiel (DE)

(73) Assignee: EASTMAN KODAK COMPANY, Rochester, NY (US)

(21) Appl. No.: 13/384,847

(22) PCT Filed: Jul. 8, 2010
(86) PCT No.: PCT/EP2010/059783

§ 371 Date: Mar. 6, 2012

(30) Foreign Application Priority Data
Jul. 12, 2009 (DE) 10 2009 034 107.2

(51) Int. Cl. G03G 15/08

(52) U.S. Cl. 399/265

(57) ABSTRACT

A developing device for transferring toner particles to a photoconductor comprises a container for holding a developer of non-magnetic toner particles and hard magnetic carrier particles, a first developer roller which is at least partially arranged in said container and features a non-magnetic jacket tube and a magnetic core, the jacket tube and the magnetic core each being arranged so as to be rotatable about corresponding rotational axes, and at least a second developer roller which is arranged adjacent to the first developer roller in such a manner that carrier particles with toner particles adhering to them and being carried along by rotation of the first developer roller, contact the second developer roller in order to transfer the toner particles in a contacting manner to the second developer roller, said second developer roller being supported so as to be rotatable about a corresponding rotational axis. There are provided at least one drive unit for rotating the jacket tube, the magnetic core and the second developer roller, each about its respective rotational axis, as well as means for generating an alternating voltage field adjacent to the second developer roller in the region of an adjacent photoconductor. In a method for generating a toner image on a photoconductor, a charge image is first formed on the photoconductor and, subsequently, toner is applied, correspondingly to the charge image, to the photoconductor by way of a developing device. When the toner is being applied, the toner particles are triboelectrically charged in a developer of non-magnetic toner particles and hard magnetic carrier particles, the carrier particles with toner particles adhering to them are brought into contact with and transported by a first developer roller comprising a rotating non-magnetic jacket tube and a magnetic core rotating inside said jacket tube, the toner particles are transferred to a second developer roller arranged adjacent to the first developer roller and rotated in such a manner that carrier particles with the toner particles adhering to them contact the second developer roller, the photoconductor is moved at a prespecified distance along the rotating second developer roller, an alternating voltage field is generated in the region between the second developer roller and the photoconductor in order to generate via this means a cloud of toner particles in this region, and the toner particles are attracted to the photoconductor corresponding to the charge image.

### TECHNICAL FIELD OF THE INVENTION

The present invention relates to a developing device for transferring toner particles to a photoconductor as well as to a method for generating a toner image on a photoconductor.

### BACKGROUND OF THE INVENTION

Various developing devices for transferring toner particles to photoconductors as well as methods for generating a toner image on a photoconductor are known in printing technology. For example, known developing devices comprise a container holding a developer of non-magnetic toner particles as well as magnetic carrier particles.

In a known developing device that is also known as a magnetic brush device, the carrier particles consist of a soft magnetic material. A developer roller is provided inside the container, said roller having a plurality of magnets on its inside and being enclosed by a jacket tube. In circumferential direction, the magnets are arranged with their respective poles facing in outward direction, and the outward facing poles of adjacent magnets are oppositely poled. The magnets are stationary, whereas the jacket tube is rotatable. Due to such an arrangement of the magnets and the jacket tube, chains of soft magnetic carrier particles with toner particles adhering to them are formed when the jacket tube is rotated. The respective chains form bristles essentially extending radially with respect to the jacket tube as in a brush, thus the reference to a magnetic brush. Usually, the length of the bristles is limited by a stripper. The bristles rotate with the jacket tube and, in so doing, repeatedly fold over during rotation due to the opposing polarity of the magnets. In this way, the bristles of carrier particles of the developer and toner particles can be brought into contact with a photoconductor in order to transfer the toner particles adhering to the bristles to the photoconductor. In this arrangement, the magnets are not necessarily symmetrically designed and, as a rule, one stationary magnet is located directly opposite the photoconductor, the stripper and, if provided, a transport roller for the developer. The soft magnetic carrier particles used in this device are relatively large. A transfer of the carrier particles to the photoconductor is to be prevented, on the one hand, by the inherent weight of the particles and, on the other hand, by a sufficient load on which the magnetic field of the magnets may act. However, due to the size of the toner particles, the amount of toner that can be transferred is limited. In addition, considering this device, there is the problem of relatively high wear of the photoconductor due to a possible contact with the carrier particles.

Instead of a direct transfer of toner particles to a photoconductor, it is also known to first transfer the toner particles by way of the magnetic brush to a second developer roller, said second developer roller being, for example, rotated in a counter-rotational manner relative to the first developer roller so that surfaces of the developer rollers facing each other will rotate in the same direction. The toner particles are transferred to the surface of the second developer roller, for example by a corresponding charge of the second developer roller, and are rotated with said roller. With the use of a suitable device, which, for example, is provided with a plurality of adjacent appropriately activated wires, an alternating voltage field is created adjacent to the second developer roller. Due to the alternating voltage field, the toner particles are being moved away from and toward the roller, and form a kind of toner cloud in the region of the alternating voltage field. If now a photoconductor with a latent charge image is passed in the region of the toner cloud, toner particles are selectively transferred to the photoconductor. Consequently, a contactless transfer of toner particles to the photoconductor is possible. As a result of this, wear of the photoconductor can be reduced; however, there is still the problem of being able to transfer only a quite limited amount of toner to the second developer roller via the magnetic brush and, consequently, to the photoconductor.

In an alternative developing device, a developer of non-magnetic toner particles and hard magnetic carrier particles is being used. The hard magnetic carrier particles can be smaller than the soft magnetic carrier particles of the developing device to be described, said device comprising a magnetic brush. Therefore, reference is made to an SPD developing device, where SPD stands for “Small Particle Developer.”

In such a developing device, a non-magnetic jacket tube and a magnetic core rotatable relative thereto are provided, the jacket tube and the magnetic core being supported so as to be rotatable about corresponding rotational axes. The magnetic core consists of a row of magnets arranged in a rotation-symmetrical manner in circumferential direction. Adjacent magnets are counter-poled. By separate rotation of the non-magnetic tube and the magnetic core, again, chains of carrier particles of toner particles adhering to them are formed, these again folding over and forming anew. In so doing, the magnetic carrier particles are being vortexed, i.e., considerably more strongly than in the above-described developing device comprising a magnetic brush. In addition, the chains that are formed are not as uniform as those with the formation of the magnetic brush. Among other things, the carrier particles are prevented from detaching from the jacket tube due to their remanence. In this type of developing device, the chains of hard magnetic carrier particles with toner particles adhering to them are brought into contact with a photoconductor in order to selectively transfer the adhering toner particles to the photoconductor. Due to the vortexing of the carrier particles, a larger proportion of toner particles on the carrier particles comes into contact with the photoconductor, thus enabling the transfer of a larger amount of toner. With the use of hard magnetic carrier particles, it is additionally possible, as mentioned, to use smaller carrier particles than with the use of the magnetic brush, thus also enabling the transfer of a larger amount of toner to the photoconductor. However, by bringing the photoconductor in contact with the vortexed carrier particles, the photoconductor is subject to increased wear.

### SUMMARY OF THE INVENTION

Considering prior art, the object of the present invention is to provide a developing device for transferring toner particles to a photoconductor, as well as to provide a method for generating a toner image on a photoconductor, thereby avoiding the aforementioned disadvantages of prior art.

In accordance with the invention, this object is achieved by a developing device as in claim 1 and by a method for generating a toner image on a photoconductor as in claim 9. Additional embodiments of the invention are obvious from the respective subclaims.

In particular, a developing device for transferring toner particles to a photoconductor is provided, said device comprising a container for holding a developer of non-magnetic toner particles and hard magnetic carrier particles. The developing device comprises a first developer roller which is at least partially arranged in the container and features a non-magnetic jacket tube and a magnetic core, the jacket tube and the magnetic core each being arranged so as to be rotatable about corresponding rotational axes. Also provided is a second developer roller which is arranged adjacent to the first developer roller in such a manner that the developer of carrier particles with toner particles adhering to them, the developer being carried along by rotation of the first developer roller, contacts the second developer roller. As a result of this, it is possible to transfer the toner particles in a contacting manner to the second developer roller. The second developer roller is supported so as to be rotatable about a corresponding rotational axis and possesses an electrical charge in order to promote the transfer of the toner particles. The developing device comprises at least one drive unit for rotating the jacket tube, the magnetic core and the second developer roller, each about its respective rotational axis, as well as means for generating an alternating voltage field adjacent to the second developer roller in the region of an adjacent photoconductor. The developing device in accordance with the invention enables, thus, a particularly uniform high-volume toner transfer from the first developer roller to the second developer roller by using the hard magnetic carrier particles. The toner particles can then be transferred in a contactless manner from the second developer roller to an adjacent photoconductor in the region of the means for generating an alternating voltage field, thus enabling a contactless development of the photoconductor. The above-described device avoids at least a few of the disadvantages of the known devices. In particular, said device allows a uniform toner application to the second developer roller with a high toner volume; this, in turn, allowing a uniform development of a photoconductor with minimal edge effects. The contactless transfer of toner to the photoconductor, thus, allows, in particular, the formation of several superimposed toner layers. As a result of this, it is possible, for example, to produce several superimposed color separations of a toner image on the photoconductor that may then be transferred together to a substrate to be printed.

Preferably, the rotational axes of the jacket tube and the magnetic core are offset relative to each other, thus resulting in an asymmetry. In particular, the rotational axis of the magnetic core is preferably located between the rotational axis of the jacket tube and the rotational axis of the second developer roller in order to result in a strong turbulent mixing of the hard magnetic carrier particles with the non-magnetic toner particles adhering to them, and to thus enable a high-volume toner transfer.

In order to achieve good vortexing of the carrier particles and the toner particles in the region between the first and the second developer rollers, the at least one drive unit is preferably suitable to rotate the jacket tube and the magnetic core in opposite directions.

In one embodiment of the invention, the second developer roller preferably consists of a metal, in particular aluminum, thus making said roller highly durable. In order to even further increase durability, the second developer preferably has a coating, in particular, a ceramic coating.

In accordance with the invention, a printing machine comprising at least one photoconductor, means for generating a latent charge image on the photoconductor, and at least one developing device of the above-described type are also provided, wherein the photoconductor can be moved at a prespecified distance past the second developer roller in the region of the means for generating the alternating voltage field, said distance being greater than a toner layer to be expected on the second developer roller. Such a printing machine makes the aforementioned advantages possible.

In one embodiment of the invention, the photoconductor comprises a photoconductor roller that is usually provided for the transfer of a single toner separation image. In an alternative embodiment, the photoconductor comprises a photoconductor belt that can be moved past a plurality of developing devices of the above type, while means for generating a latent charge image on the photoconductor are provided between the developing devices. Such a photoconductor allows the superimposed formation of a plurality of toner layers, before said toner layers are transferred to a printing material. Consequently, only a single transfer of a toner image from a single photoconductor to a printing material is necessary in order to form, for example, a multi-color picture on the printing material.

The object underlying the invention is also achieved by a method for generating a toner image on a photoconductor, wherein a charge image is first formed on the photoconductor and, subsequently, toner is applied, correspondingly to the charge image, to the photoconductor by way of a developing device. When the toner is being applied, the toner particles are triboelectrically charged in a developer of non-magnetic toner particles and hard magnetic carrier particles, the carrier particles with toner particles adhering to them are brought into contact with and transported by a first developer roller comprising a rotating non-magnetic jacket tube and a magnetic core rotating inside said jacket tube. Furthermore, the toner particles are transferred to a second developer roller arranged adjacent to the first developer roller and rotated in such a manner that carrier particles with toner particles adhering to them contact the second developer roller. The transfer of the toner particles is promoted by an electrical potential difference between the first and the second developer rollers. The photoconductor is moved at a prespecified distance along the rotating second developer roller, an alternating voltage field is generated in the region between the second developer roller and the photoconductor in order to generate via this means a cloud of toner particles in this region, thus causing the toner particles to be attracted to the photoconductor correspondingly to the charge image. This method makes possible the contactless high-volume transfer of toner particles to a photoconductor.

Preferably, the jacket tube and the magnetic core are rotated in opposite directions.

In one embodiment of the invention, at least one additional charge image is formed on the photoconductor with the toner applied to said photoconductor and, subsequently toner is applied correspondingly to the additional charge image to the photoconductor by means of at least another developing device. As a result of this, several superimposed toner layers can be applied to the photoconductor as desired and consistent with the charge image. Due to the contactless transfer of toner particles on the photoconductor, it is possible to form several superimposed toner layers, without substantially impairing the respectively lower toner layer.

In one embodiment, the photoconductor comprises a photoconductor belt that is moved past a plurality of developing devices, each transferring toner to the photoconductor, i.e., correspondingly to the latent charge images on the photoconductor, said images being formed between the developing devices.

### BRIEF DESCRIPTION OF THE DRAWINGS

Hereinafter, the invention will be described in greater detail with reference to the drawings. They show in

FIG. 1 a schematic side view of an electrophotographically operating printing machine;

FIG. 2 a schematic side view of a printing unit of the electrophotographically operating printing machine as in FIG. 1;

FIG. 3 a schematic side view of a printing region of an alternative electrophotographically operating printing machine.

### DETAILED DESCRIPTION OF THE INVENTION

Information regarding locations and directions used in the description hereinafter relates primarily to the representations in the drawings and is thus not to be viewed as being restricting. However, it may also relate to a preferred final arrangement.

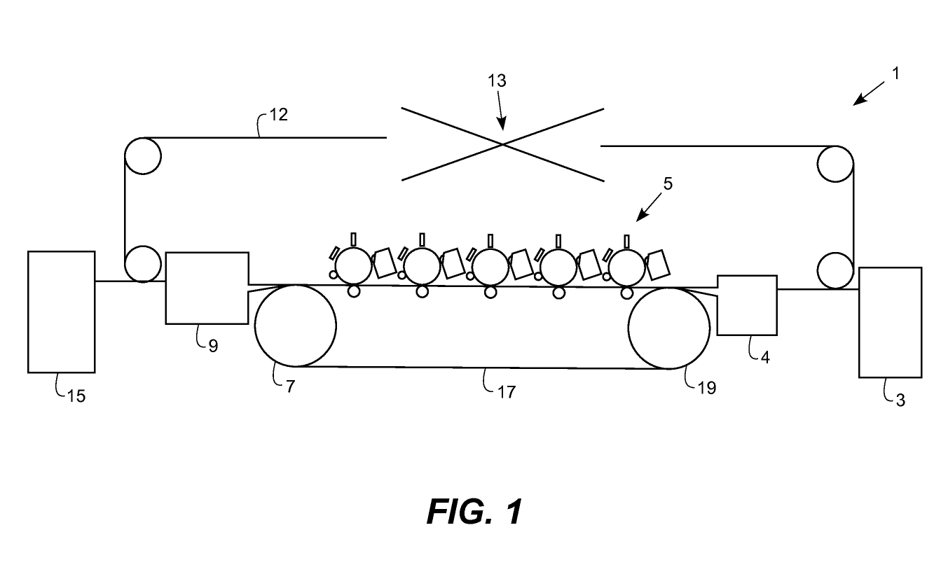

FIG. 1 shows a schematic side view of a multi-color printing machine 1 comprising a feeder 3, an alignment unit 4, a plurality of printing units 5, a transport unit 7, a fusing unit 9, a duplex path 12 with a turning unit 13, as well as an output tray 15. The most diverse embodiments of such multi-color printing machines 1 are known, and FIG. 1 depicts only a highly simplified example of such a printing machine.

The feeder 3 is disposed to hold a stack of sheets and to feed individual sheets to the alignment unit 4, and is shown at a first end of the printing machine 1. However, said feeder may also be arranged at any other location and need not feed sheets directly to the alignment unit 4.

The alignment unit 4 is of a suitable type that aligns the fed sheets in a suitable manner and transfers them to the transport unit 7. The transport unit 7 is of a known type that is suitable to transport sheets past the printing units 5. In the depicted embodiment, the transport unit 7 comprises a circulating transport belt 17 that is guided around corresponding transport and guide rollers 19.

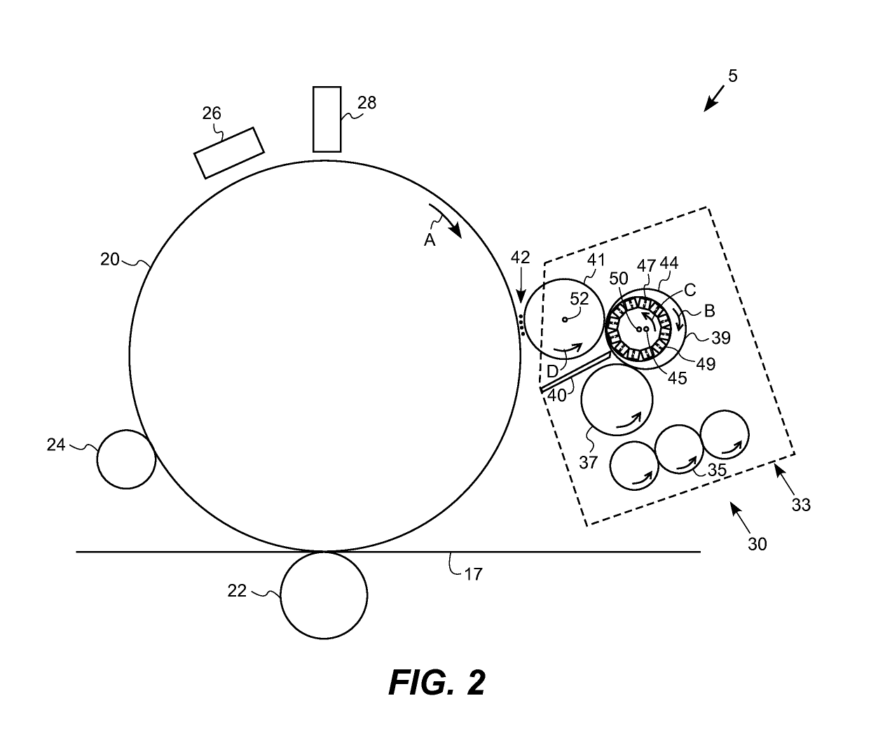

The printing units 5 that are shown in greater detail in FIG. 2 are suitable for printing respective color separation images on the sheets that are transported by the transport unit 7. The shown multi-color printing machine 1 has five printing units 5 that, for example, may be operated with the colors black, cyan, magenta, yellow and one custom color such as, for example, clear dry ink. Each of the printing units 5 comprises an imaging drum 20, a pressure roller 22, a cleaning unit 24, a charging unit 26, an exposure unit 28, as well as a developer unit 30. The pressure roller 22, the cleaning unit 24, the charging unit 26, the exposure unit 28, as well as the developer unit 30, are arranged around the imaging drum in a manner known per se.

The imaging drum 20 has a photoconductive surface as is known in the art and is in contact with the transport belt. The imaging drum 20 is supported so as to be rotatable. The imaging drum 20 may be driven via its own drive, or it may also be rotated, for example, by friction with the transport belt 17 of the transport unit 7. In particular, a rotation of the imaging drum 20 in the direction of arrow A is intended. Although it is not shown, an intermediate drum—as is known from the art—may be provided between the imaging drum 20 and the transport belt 17.

The pressure roller 22 is provided adjacent to the imaging drum 20 in such a manner that a pressure gap is formed through which the transport belt 17 of the transport unit 7, as well as a sheet that is to be printed, may be guided. The pressure roller 22 may be put under tension in order to facilitate toner transfer from the imaging drum to one of the sheets to be printed.

The cleaning unit 24—viewed in the advance direction A of the imaging drum—may be arranged between the pressure roller 22 and a charging unit 26. The cleaning unit 24 may also be of a known type that cleans a surface of the imaging drum.

The charging unit 26 of the printing units 5—viewed in advance direction A of the imaging drum—is arranged between the cleaning unit 24 and the exposure unit 28 and comprises a corona device, for example. The charging unit 26 is suitable to generate a uniform charge on the surface of the imaging drum 20. The exposure unit 28—viewed in advance direction A of the imaging drum 20—is provided between the charging unit 26 and the developer unit 30. The exposure unit 28 is of a suitable type in order to provide a local electrical discharge of the surface of the imaging drum 20, in the manner known in the art. The charging unit 26 and the exposure unit 28 are thus capable of generating a latent charge image on the surface of the imaging drum 20.

The developer unit 30—viewed in advance direction A of the imaging drum 20—is arranged between the exposure unit 28 and the pressure roller 22 and is disposed to transfer toner particles to the imaging drum 20, consistent with a latent image on said imaging drum, as is known from the art. The developer unit 30 comprises a housing 33, said housing comprising a space for the accommodation of a developer in a manner known per se. The developer unit 30 is specifically designed for the use of a developer with hard magnetic carrier particles and non-magnetic toner particles. Provided in the housing 33 are a plurality of mixing rollers 35, a transport roller 37, a first developer roller 39, a stripper 40, as well as a second developer roller 41. As will be explained in greater detail hereinafter, the second developer roller 41 partially projects from the housing 33 and is arranged adjacent to the imaging drum 20. Means 42 for generating an alternating voltage field are provided in a gap between the second developer roller 41 and the imaging drums 20, said means being, for example, a plurality of wires that can be activated by means of a not illustrated control unit.

The mixing rollers 35 are rotatable (see arrows) inside a holding space for the developer and, in a manner known per se, are disposed to thoroughly mix the non-magnetic toner particles and impart them with a triboelectric charge. Such mixing rollers are known in the art and will not be explained in detail herein.

The transport roller 37 is also provided in the space used for holding the developer and is suitable, in a manner known per se, for transporting the developer in the region of the first developer roller 39 by rotating said transport roller (see arrow). To do so, the transport roller 37 may be provided on its outside circumference, for example, with appropriate indentations disposed to receive and transport developer.

The first developer roller 39 comprises a non-magnetic jacket tube 44. The jacket tube 44 is supported so as to be rotatable about a rotational axis 45, and can be rotated in the direction of arrow B via a not specifically illustrated drive unit. A magnetic core 47 is provided inside the jacket tube 44. The magnetic core 47 has the form of a roller. The magnetic core 47 has a plurality of magnets 49 that are arranged adjacent to each other in circumferential direction, adjacent magnets being respectively poled in opposite direction. The magnetic core 47 is supported so as to be rotatable about a rotational axis 50 and can be rotated in the direction of arrow C via a not specifically illustrated drive unit. As is obvious from FIG. 2, arrows B and C go in opposite directions so as to make clear that the magnetic core 47 is counter-rotational to jacket tube 44. Furthermore, FIG. 2 shows that the rotational axis 45 of the jacket tube 44 is offset relative to the rotational axis 50 of the magnetic core 47. In particular, the rotational axis 50 is offset in the direction of the second developer roller 41.

The stripper 40 is arranged adjacent to the first developer roller and is disposed to limit—in a manner known per se—the thickness of a developer layer that is moved with the jacket tube. The stripper is positioned in such a manner that it strips developer off the jacket tube in the direction of the transport roller or the mixing rollers. Furthermore, the stripper has the function of a separating wall in order to limit the space holding the developer relative to the second developer roller.

The second developer roller 41 is arranged adjacent to the first developer roller 39, a small gap being formed between the first developer roller 39 and the second developer roller 41.

The second developer roller 41 is supported so as to be rotatable about a rotational axis 52 and rotatable in the direction of arrow D via a not specifically illustrated drive unit. Arrow D opposes arrow B, so that the jacket tube 44 and the second developer 41 are rotated in opposite directions. The second developer roller 41 consists of metal, preferably aluminum, and may have a ceramic coating. Not specifically illustrated means are provided to generate an electrical potential difference between the first developer roller 39 and the second developer roller 41 in order to promote a transfer of triboelectrically charged toner particles.

As mentioned previously, the second developer roller 41 is arranged in such a manner that it extends partially from the housing 33 of the developer unit 30. In particular, the second developer roller 41 is arranged in such a manner that it faces the surface of the imaging drum 20. As previously mentioned, means 42 for generating an alternating voltage field 42 are provided in a gap between the imaging drum 20 and the second developer roller 41. The means 42 are represented as adjacent wires that can be activated by way of a not specifically illustrated control unit in order to generate the alternating voltage field.

Each of the printing units 5 is designed in the same manner; however, usually, they are loaded with toner particles of different colors in order to produce color separation images on a printing material, whereby these can be subsequently fused in the fusing unit 9.

The fusing unit 9 is of any type disposed to fuse the toner to a printing material. This may be accomplished, for example, by heated pressure rollers or also by other suitable devices such as, for example, a contactless heating device that operates with light or other electromagnetic radiation such as, for example, microwaves.

The fusing unit 9 is followed by the duplex path 12 that, in a manner known per se, provides a sheet transport path back to the alignment unit 4. In the duplex path 12, a turning arrangement 13 is provided that, in a manner known per se, can turn a sheet that is being transported along the duplex path 12. If a sheet is not to be directed to the duplex path 12 downstream of the fusing unit 9, it is also possible to guide said sheet—via an appropriate diverter—to the output tray 15.

Hereinafter, with reference to FIGS. 1 and 2, a process for printing a printing material such as, for example, a paper sheet, will be explained in greater detail.

First, a feeder 3 is used to place a paper sheet against the alignment unit 4, and said paper sheet is suitably aligned. Subsequently, the paper sheet is transferred to the transport belt 17 of the transport unit 7 and, for example, held thereon in an electrostatic manner. The transport belt 17 is transported in a circulating manner in order to guide the paper sheet along the printing units 5. The imaging drum 20 is rotated in the printing units 5 in a manner known per se, and a uniform charge is applied by means of the charging unit 26. The exposure unit 28 then performs a local discharge of the surface of the imaging drum 20 in order to generate a latent charge image. The latent charge image is then moved past the developer unit 30 by rotating the image drum 20, and toner is transferred to the imaging drum 20 consistent with the latent charge image, as will be explained in greater detail hereinafter.

Subsequently, the toner image that has been generated in this manner is continued to be moved with the imaging drum 20 and is then transferred to the paper sheet in the region between the imaging drum 20 and the pressure roller 22. Due to the plurality of printing units, different color separation images of a multi-color printed picture are suitably transferred to the paper sheet. Now the paper sheet with the toner layers applied thereto is guided through the fusing unit 9 in which the toner image is fused. Subsequently, the paper sheet may be guided to the output tray 15. If the paper sheet is to be printed on both sides, said paper sheet may be transported back to the alignment unit 4 via the duplex path 12, the paper sheet being turned by the turning unit 13 during this transport in order to enable printing of the second side of the paper sheet.

Hereinafter, the transfer of toner to the imaging drum in the region of the developer unit will be explained in greater detail. The developer of hard magnetic carrier particles and non-magnetic toner particles is first mixed by mixing rollers 35 and triboelectrically charged inside the developer unit 30. The transport roller 37 transports the developer that has been charged in this manner into the region of the first developer roller 39. The hard magnetic carrier particles with the toner particles adhering to them are then attracted to the jacket tube 44 by the magnetic core 47. By rotating the jacket tube 44 in the direction of arrow B, the carrier particles are then moved in the direction of the gap between the jacket tube 44 and the second developer roller 41.

Due to the counter-rotational movement of the magnetic core 47 and the jacket tube 44, the hard magnetic carrier particles with the toner particles adhering to them are repeatedly vortexed on the surface of the jacket tube 44 and form some chains that collapse again. The remanence of the hard magnetic carrier particles essentially prevents the hard magnetic carrier particles from falling off. In the gap between the first developer roller 39 and the second developer roller 41, the hard magnetic carrier particles with the adhering toner particles that have been vortexed in such a manner also come into contact with the second developer roller 41. In so doing, the non-magnetic toner particles are transferred to the second developer roller 41, facilitated by an electrical potential difference between the first and second developer rollers 39 and 41, respectively. In contrast, the hard magnetic carrier particles are attracted through the magnetic core 47 to the jacket tube 44 and remain on the latter. The second developer roller 41 is, thus, provided with a uniform toner layer. This layer may have a relatively large toner volume because the hard magnetic carrier particles may be smaller in size than the soft magnetic carrier particles that are used in a magnetic brush device. Furthermore, vortexing of the carrier particles also enables a better toner transfer to the second developer roller.

By rotating the second developer roller 41, this uniform toner layer is transported into the region of the gap between the second developer roller 41 and the imaging drum 20. The means 42 generate an alternating voltage field in the gap, as a result of which the toner particles on the second developer roller 41 are moved in the direction of the imaging drum 20 and back again to the second developer roller 41 in the region of the alternating voltage field. As a result of this, the toner particles form kind of a toner cloud in the gap between the imaging drum 20 and the second developer roller 41. If the imaging drum 20 now carries a charge such as, for example, in the region of the latent charge image, this causes the toner particles in the cloud in the region of the latent charge image to be attracted to the imaging drum 20, thus causing the formation of the latent toner image on the imaging drum 20.

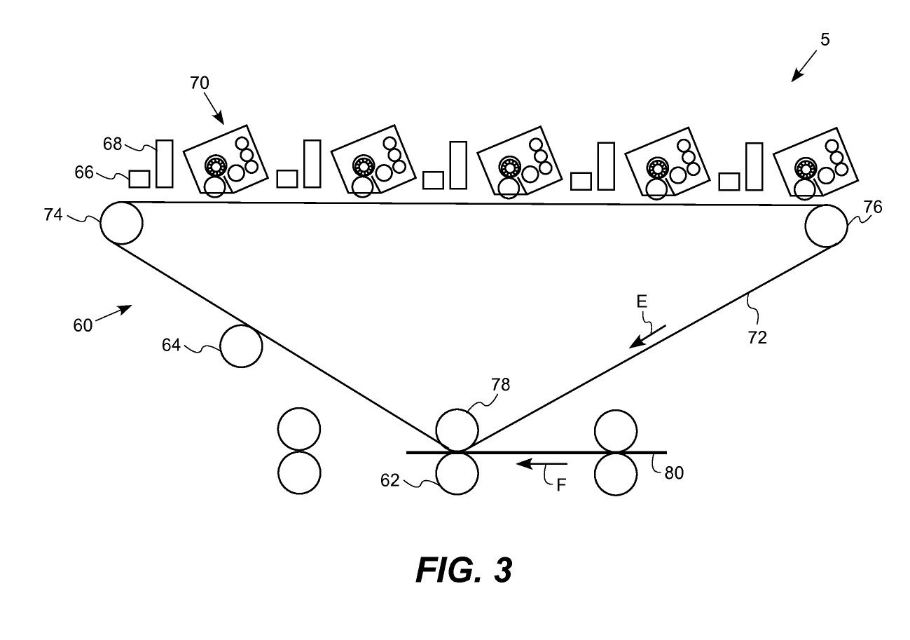

FIG. 3 shows a schematic side view of a printing region of an alternative electrophotographically operating printing machine that may essentially be designed in the same manner as the first embodiment in accordance with FIG. 1, namely, regarding a feeder, an alignment unit, a transport unit, a fusing unit, a duplex path, a turning unit and an output tray 15. Therefore, the latter are not illustrated in greater detail in FIG. 3. However, the design of a printing unit 5 is different. In the embodiment of FIG. 3, a single printing unit 5 is provided. Accordingly, the transport unit can be shown considerably more compact than in FIG. 1.

The printing unit 5 comprises a photoconductor unit 60, a pressure roller 62, a cleaning unit 64, a plurality of charging units 66, a plurality of exposure units 68, as well as a plurality of developer units 70

The photoconductor unit 60 comprises a photoconductor belt 72 that is guided around guide and/or transport rollers 74, 76 and 78. The photoconductor belt 72 can be moved in the direction of arrow E in a manner so as to circulate around one of the guide and/or transport rollers 74, 76 and 78 of the not specifically shown drive unit. Of course, it is also possible to move the photoconductor belt by frictional contact with a corresponding transport element of a transport unit in order to transport the printing material in a circulating manner.

The pressure roller 62 is arranged in the region of the guide and/or transport roller 78 for the photoconductor belt 72 and presses against the guide and/or transport roller 78 in such a manner that a printing gap is formed therebetween. A printing material such as, for example, a paper sheet 80, that is transported in the direction of arrow F can be moved together with the photoconductor belt 72 through the printing gap between the pressure roller 62 and the guide and/or transport roller 78, as is schematically indicated in FIG. 3.

The cleaning unit 64 is in cleaning contact with the photoconductor belt 72, i.e., between the guide and/or transport rollers 78 and 74. The photoconductor belt 72 forms a strand between the guide and/or transport rollers 74 and 76, to which strand toner is transferred. To do so, five adjacent units are provided, each comprising a charging unit 66, an exposure unit 68 and a developer unit 70 located next to each other, as can be seen in FIG. 3.

The charging units 66 are of a suitable type such as, for example, a corona device, in order to generate a uniform charge on the photoconductor belt 72. Again, the exposure unit 68 is of a suitable type to provide a local discharge of the charge belt 72 in order to generate a latent charge image. Each of the developer units 70 is of the same type as the aforementioned developer unit 30, and they are arranged in such a manner that they can transfer toner to a photoconductor belt consistent with a latent charge image, as described above.

As a result of the fact that the toner can be transferred in a contactless manner to the photoconductor belt 72 by the developer units 70, it is possible to again provide said photoconductor belt 72 with a new uniform charge, a local discharge and a renewed toner transfer in accordance with the thusly generated latent toner image. As is indicated in FIG. 3, this may be repeated multiple times (depending on the number of units comprising a charging unit 66, an exposure unit 68, as well as a developer unit 70). As a result of this, several toner layers, in particular toner layers having different colors, can be formed on the photoconductor belt 72, this enabling the formation of a multi-color toner image on the photoconductor belt 72, said toner image being then transferred—in the printing gap between the pressure roller 62 and the guide and/or transport roller 78—to a printing material. Consequently, only a single toner transfer to the printing material 80 is provided.

Hereinabove, the invention has been explained in greater detail with reference to two preferred exemplary embodiments of the invention, without being restricted to the specifically presented embodiments. In particular, the presented developing device may be designed differently from the one specifically shown and may interact with other photoconductors.

1. Developing device for transferring toner particles to a photoconductor, said device comprising
a container for holding a developer of non-magnetic toner particles and hard magnetic carrier particles;
a first developer roller which is at least partially arranged in said container and features a non-magnetic jacket tube and a magnetic core, the jacket tube and the magnetic core each being arranged so as to be rotatable about corresponding rotational axes;
at least a second developer roller which is arranged adjacent to the first developer roller in such a manner that carrier particles with toner particles adhering to them and being carried along by rotation of the first developer roller, contact the second developer roller in order to transfer the toner particles in a contacting manner to the second developer roller, said second developer roller being supported so as to be rotatable about a corresponding rotational axis;
at least one drive unit for rotating the jacket tube, the magnetic core and the second developer roller, each about its respective rotational axis; and means for generating an alternating voltage field adjacent to the second developer roller in the region of an adjacent photoconductor.

2. Developing device as in claim 1, wherein the rotational axes of the jacket tube and the magnetic core are offset relative to each other.

3. Developing device as in claim 1, wherein the rotational axis of the magnetic core is located between the rotational axis of the jacket tube and the rotational axis of the second developer roller.

4. Developing device as in claim 1 wherein the at least one drive unit is suitable to rotate the jacket tube and the magnetic core in opposite directions.

5. Developing device as in claim 1, wherein the second developer roller consists of a metal, in particular, aluminum.

6. Developing device as in that claim 1 wherein the second developer roller has a coating, in particular, a ceramic coating.

7. Printing machine comprising at least one photoconductor, means for generating a latent charge image on the photoconductor, and at least one developing device as in claim 1, wherein the photoconductor can be moved at a prespecified distance past the second developer roller in the region of the means for generating the alternating voltage field, said distance being greater than a toner layer to be expected on the second developer roller.

8. Printing machine as in claim 7, wherein the photoconductor comprises a photoconductor roller.

9. Printing machine as in claim 7, wherein the photoconductor comprises a photoconductor belt that can be moved past a plurality of developing devices, means for generating a latent charge image being provided on the photoconductor between the development devices.

10. Method for generating a toner image on a photoconductor, wherein a charge image is first formed on the photoconductor and, subsequently, toner is applied, correspondingly to the charge image, to the photoconductor by way of a developing device, the application of the toner comprising the following steps:
triboelectrically charging the toner particles in a developer of non-magnetic toner particles and hard magnetic carrier particles;
bringing the carrier particles into contact with toner particles adhering to them and transporting them by means of a first developer roller comprising a rotating non-magnetic jacket tube and a magnetic core rotating inside said jacket tube;
transferring the toner particles to a second developer roller arranged adjacent to the first developer roller and rotated in such a manner that carrier particles with toner particles adhering to them contact the second developer roller;
moving the photoconductor at a prespecified distance along the rotating second developer roller;
generating an alternating voltage field in the region between the second developer roller and the photoconductor in order to generate via this means a cloud of toner particles in this region; and
attracting the toner particles to the photoconductor corresponding to the charge image.

11. Method as in claim 10, wherein the jacket tube and the magnetic core are rotated in opposite directions.

12. Method as in claim 10, wherein at least one additional charge image is formed on the photoconductor with the toner applied to said photoconductor and, subsequently, toner is applied to the photoconductor correspondingly to the additional charge image by means of at least another developing device.

13. Method as in claim 10, wherein the photoconductor comprises a photoconductor belt that is moved past a plurality of developing devices, each transferring toner to the photoconductor, i.e., corresponding to the latent charge images on the photoconductor, said images being formed between the developing devices.
